(19) United States
(12) Patent Application Publication
(10) Pub. No.: US 2014/0032408 A1
(43) Pub. Date: Jan. 30, 2014

(54) ELECTRONIC TRANSACTION DOCUMENTATION

(71) Applicants: Hyun Gyu SHIN, Namyangju-si (KR); Jeong Hyun SEO, Seongnam-si (KR)

(72) Inventors: Hyun Gyu SHIN, Namyangju-si (KR); Jeong Hyun SEO, Seongnam-si (KR)

(73) Assignee: LG CNS CO., LTD., Seoul (KR)

(21) Appl. No.: 13/559,735

(22) Filed: Jul. 27, 2012

(51) Int. Cl. G06Q 20/32

(52) U.S. Cl. CPC G06Q 20/322
USPC 705/44; 705/39

(57) ABSTRACT

Embodiments described herein provide approaches for managing electronic documentation of transactions. Specifically, transaction details of an approved transaction between a user and a merchant terminal are sent to a mobile device document generator to create an electronic document memorializing the transaction. Based on the type of mobile device operated by the user, the mobile document is sent to the mobile device of the user according to an optimal communication transmission mode.

### CROSS-REFERENCE TO RELATED APPLICATIONS

This application is based on and claims priority from Korean Patent Application No. KR 10-2011-0075032, filed on Jul. 28, 2011, with the Korean Intellectual Property Office, the present disclosure of which is incorporated herein in its entirety by reference.

### BACKGROUND

1. Technical Field

The present invention relates generally to management of sale transaction data, and more particularly, to approaches for providing electronic documents of transactions via a mobile device.

2. Related Art

Point-of-sale (“POS”) devices and automatic teller machines (ATMs) are widely used throughout the world. With most ATMs and POS devices, after performing a transaction, a paper receipt is automatically generated for a customer. Often, however, the customer discards these receipts prior to using/downloading the recorded information. Therefore, the receipts account for a significant amount of wasted paper and may serve no actual purpose since the information recorded on the receipt may be lost to the customer. Further, even for customers who may desire to utilize receipts to keep records of POS transactions and/or for return purposes, the receipts—because of the size and/or composition of the receipts, the inconvenience of transferring data from the receipt to a recording system, and/or the like—may not provide for accurate and/or convenient recordation of POS transactions.

Another issue with receiving receipts from a POS device is that they are typically merchant-specific. In other words, the merchant dictates what is on the receipt, which in turn is often dictated by the specific equipment used to generate the receipt at the POS. For instance, a typical paper receipt from a restaurant may include the date of the transaction and the transaction amount. This may pose problems for those wanting to electronically capture and process itemized transaction data, and may require significant transformation or pre-processing of the data, if it exists at all.

U.S. Pat. No. 7,487,912 describes methods and systems for electronically receipting POS transactions and, in some embodiments, providing the electronic receipts to a destination selected by a party to the POS transaction.

United States Patent Application US20030055733 describes memorialization of commercial transactions via an electronic receipt including establishing a connection between a mobile device and an electronic receipt terminal, and transmitting an electronic receipt of a commercial transaction from the electronic receipt terminal to the mobile device.

United States Patent Application No. US20110125598 describes managing electronic receipts of sales transactions using a receipt capture device that generates receipt data using information from a point-of-sales (POS) terminal, and a mobile device that receives the receipt data from the receipt capture device using short range communication.

Therefore, what is needed is a solution that addresses at least one of the deficiencies of the current art.

### SUMMARY

In general, embodiments described herein provide approaches for managing electronic documentation of transactions. Specifically, transaction details of an approved transaction between a user and a merchant terminal are sent to a mobile device document generator to create an electronic document memorializing the transaction. Based on the type of mobile device operated by the user, the mobile document is sent to the mobile device of the user according to an optimal communication transmission mode.

One aspect of the present invention includes a method for managing electronic documentation of transactions, the method comprising the computer-implemented steps of: receiving information about a transaction entered into by a user; generating a mobile document containing the information about the transaction; determining a communication transmission mode based on a type of mobile device of the user; and sending the mobile document to the mobile device of the user according to the communication transmission mode.

Another aspect of the present invention provides a system for managing electronic documentation of transactions, the system comprising: a memory medium comprising instructions; a bus coupled to the memory medium; and a processor coupled to a mobile device document generator via the bus that when executing the instructions causes the system to: receive information about a transaction entered into by a user; generate a mobile document containing the information about the transaction; determine a communication transmission mode based on a type of mobile device of the user; and send the mobile document to the mobile device of the user according to the communication transmission mode.

Another aspect of the present invention provides a computer-readable storage medium storing computer instructions, which, when executed, enables a computer system to manage electronic documentation of transactions, the computer instructions comprising: receiving information about a transaction entered into by a user; generating a mobile document containing the information about the transaction; determining a communication transmission mode based on a type of mobile device of the user; and sending the mobile document to the mobile device of the user according to the communication transmission mode.

Another aspect of the present invention provides a method for managing electronic documentation of transactions, the method comprising: receiving, via a computer system, information about a transaction entered into by a user; generating, via the computer system, a mobile document containing the information about the transaction; determining, via the computer system, a communication transmission mode based on a type of mobile device of the user; and sending, via the computer system, the mobile document to the mobile device of the user according to the communication transmission mode.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a representation of network diagram according to illustrative embodiments;

FIG. 2 shows a representation of an exemplary computer implementation according to illustrative embodiments;

FIG. 3 shows a representation of the mobile device document generator according to illustrative embodiments;

FIG. 4 shows an operational flow chart for providing electronic documents via a mobile device according to illustrative embodiments;

FIG. 5 shows an operational flow chart for providing electronic documents via a mobile device according to illustrative embodiments;

FIG. 6 shows an operational flow chart for providing electronic documents via a mobile device according to illustrative embodiments; and

FIG. 7 shows an operational flow chart for providing electronic documents via a mobile device according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments now will be described more fully herein with reference to the accompanying drawings, in which exemplary embodiments are shown. Embodiments described herein provide approaches for managing electronic documentation of transactions. Specifically, transaction details of an approved transaction between a user and a merchant terminal are sent to a mobile device document generator to create an electronic document memorializing the transaction. Based on the type of mobile device operated by the user, the mobile document is sent to the mobile device of the user according to an optimal communication transmission mode.

It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

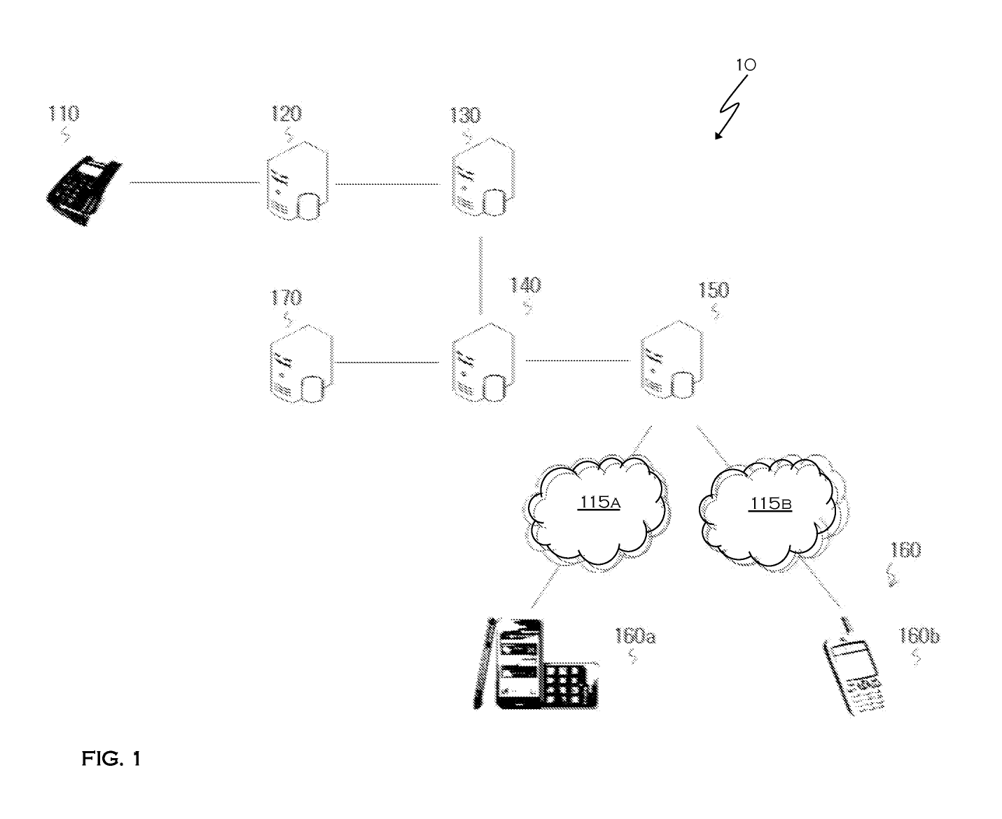

With reference now to the figures, FIG. 1 shows a pictorial representation of a mobile document publishing system 10 in which aspects of the illustrative embodiments may be implemented. Mobile document publishing system 10 is a network of computers (e.g., mobile devices) and servers (e.g., agents) in which embodiments may be implemented. Mobile document publishing system 10 contains network 115, which is the medium used to provide communications links between various mobile devices, servers, and computers connected together within mobile document publishing system 10. Network 115 may include connections, such as wire, wireless communication links, or fiber optic cables. Mobile devices 160a (e.g., a smart phone, tablet computer) and 160b (e.g., a feature phone, cellular phone) connect to networks 115a and 115b, respectively. Network 115a includes worldwide collection of networks and gateways that use the Transmission Control Protocol/Internet Protocol (TCP/IP) suite of protocols to communicate with one another. In one embodiment, mobile device 160a may send and receive push-notification messages via internet-based network 115a. Push notification messages are communicated through a constantly-open IP connection to forward notifications from various servers to enabled devices. Such notifications may include badges, sounds, custom text alerts and, in exemplary embodiments, mobile documents.

Mobile device 160b connects through cellular network 115b. Cellular network 115b comprises a radio network distributed over land areas called cells, each served by at least one fixed-location transceiver, known as a cell site or base station. In a cellular network, each cell uses a different set of frequencies from neighboring cells, to avoid interference and provide guaranteed bandwidth within each cell. When joined together these cells provide radio coverage over a wide geographic area. This enables a large number of portable transceivers (e.g., mobile device 160b) to communicate with each other and with fixed transceivers and telephones anywhere in the network, via base stations, even if some of the transceivers are moving through more than one cell during transmission.

As shown, mobile document publishing system 10 further includes a merchant terminal agent 110, a billing agent 120, a payment authorization agent 130, a mobile device document generator 140, communication manager agent 150, and expenditures agent 170, all of which will be described in greater detail below.

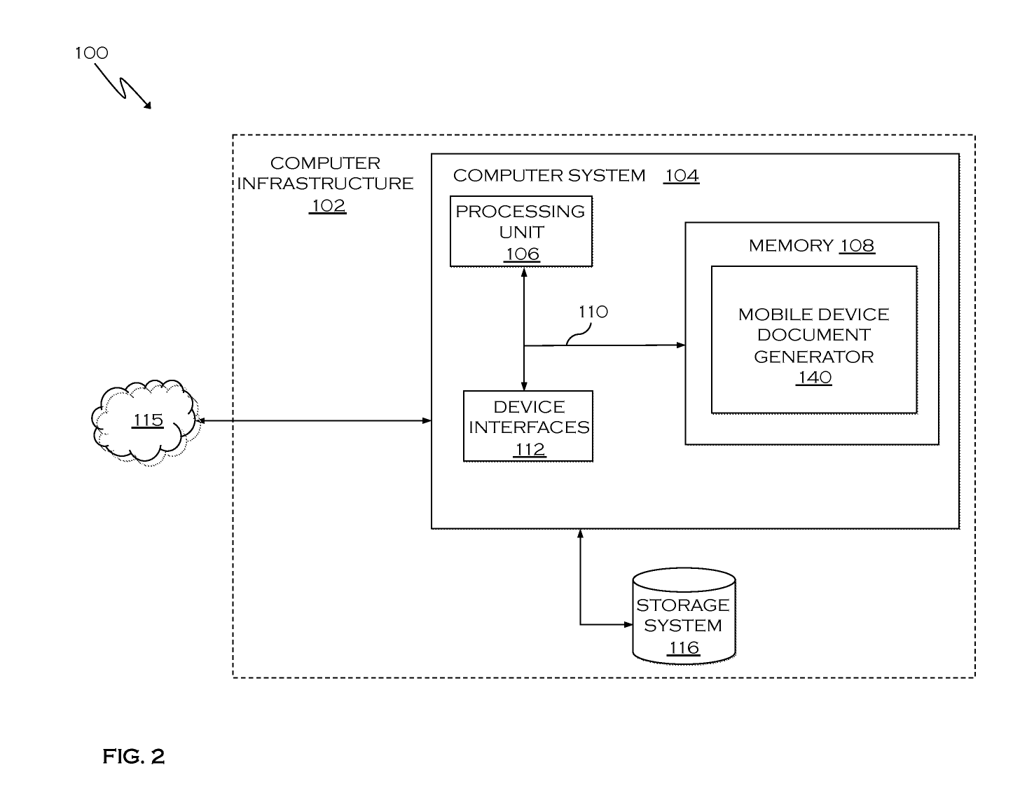

Turning now to FIG. 2, a computerized implementation 100 of the present invention will be described in greater detail. As depicted, implementation 100 includes computer system 104 deployed within a computer infrastructure 102. This is intended to demonstrate, among other things, that the present invention could be implemented within network environment 115 (e.g., the Internet, a wide area network (WAN), a local area network (LAN), a virtual private network (VPN), etc.), or on a stand-alone computer system. Still yet, computer infrastructure 102 of computerized implementation 100 is intended to demonstrate that some or all of the components could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for providing management of electronic documentation of transactions. It should be understood that any other computers implemented under the present invention may have different components/software, but will perform similar functions. As shown, computer system 104 includes a processing unit 106 capable of operating with mobile device document generator 140 stored in a memory unit 108 to manage electronic documentation of transactions, as will be described in further detail below. Also shown is a bus 110, and device interfaces 112.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 collects and routes data from merchant terminal agent 110 and mobile devices 160a, 160b (FIG. 1). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating mobile device document generator 140, which is stored in memory 108 and/or storage system 116. While executing computer program code, processing unit 106 can read and/or write data to/from memory 108 and storage system 116. Storage system 116 can include VCRs, DVRs, RAID arrays, USB hard drives, optical disk recorders, flash storage devices, and/or any other data processing and storage elements for storing and/or processing data. Although not shown, computer system 104 could also include I/O interfaces that communicate with one or more hardware device components of computer implementation 102 that enable a user to interact with computer system 104 (e.g., a keyboard, a display, camera, etc.).

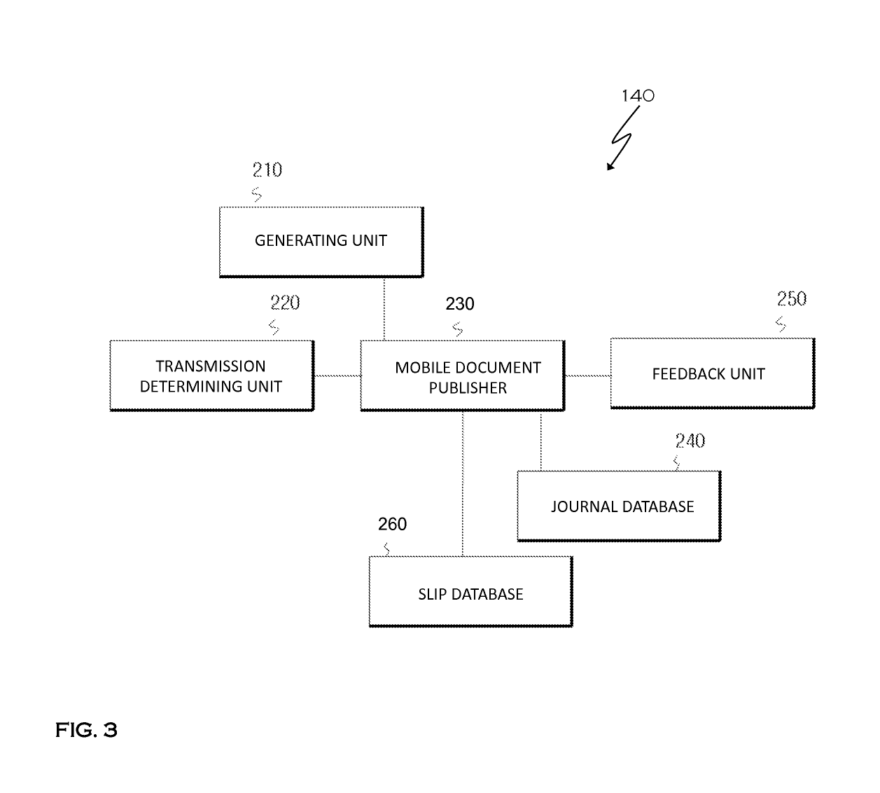

Referring now to FIGS. 1 and 3, the structure and operation of mobile device document generator (or “generator”) 140 will be described in greater detail. In exemplary embodiments, generator 140 operates with merchant terminal agent 110 (FIG. 1). Merchant terminal agent 110 is an electronic device used by a merchant or any seller of goods and/or services (e.g., ATMs) to execute sales transactions, which may involve generating paper receipts and getting authorizations for credit/debit payments from a card company via one or more servers.

When credit/debit payments are used in the sales transactions, a transaction request from merchant terminal agent 110 is sent to billing agent 120 and payment authorization agent 130, which may be part of a card company and/or bank. Authorization agent 130 retrieves account information from the associated account of the user, and determines whether to approve or deny the transaction request. In one embodiment, the account information contains an identifier (e.g., a mobile telephone number) that links the account to the mobile device of the account user. In an alternative embodiment, the identifier is contained in communication manager agent 150, which may be separate from authorization agent 130 of the card company.

Next, if the transaction is approved by authorization agent 130, a transaction approval confirmation including the identifier is forwarded to mobile document data generating unit 210, which then generates an electronic mobile document for the transaction. The mobile document contains information regarding the transaction (e.g., billing date, billing location, cost of an item, amount of money withdrawn, etc.), and is memorialized in the form of a mobile journal or a slip. In exemplary embodiments, a mobile journal contains all transaction data (payment ID, date, time, location, cost, etc.) related to each transaction, while a slip represents electronic version of a paper receipt that is commonly generated for a sales transaction, ATM transaction, etc. In one embodiment, mobile document data generating unit 210 creates an access key associated with the mobile documents for identification and storage/retrieval purposes.

Once the mobile document is created, a communication transmission mode is determined based on a type of mobile device of the user. To accomplish this, generator 140 further comprises a transmission determining unit 220 configured to determine an operating system and the type of mobile device operated by the user. This information is used to optimize the communication protocol accordingly. For example, if it is determined that the user is operating a smart phone, then communication is configured to operate with internet-based network 115a. However, if it is determined that the mobile device is a cellular phone or a feature phone (e.g., a non-smart phone having additional functionality over and above standard mobile services), then communication is configured for cellular network 115b. In another embodiment, the type of transmission mode may be based on the size of the data of a given slip. For example, if the data size is less than a predetermined size, then the slip is sent normally. However, if the data size is greater than the predetermined size, then the slip may be converted (i.e., reduced) based on the type of mobile device being used, and sent in an alternative form (e.g., multimedia messaging service (MMS)).

Next, the mobile document is sent to the mobile device of the user according to the communication transmission mode. As shown, generator 140 further comprises mobile document publisher 230 configured to send the mobile document to either device 160a or 160b using networks 115a and 115b, respectively. The mobile documents are then stored in respective databases, i.e., slips within slip database 260 and mobile journals within journal database 240. Feedback unit 250 then returns the mobile document transmission information back to authorization agent 130 once it is sent to the user.

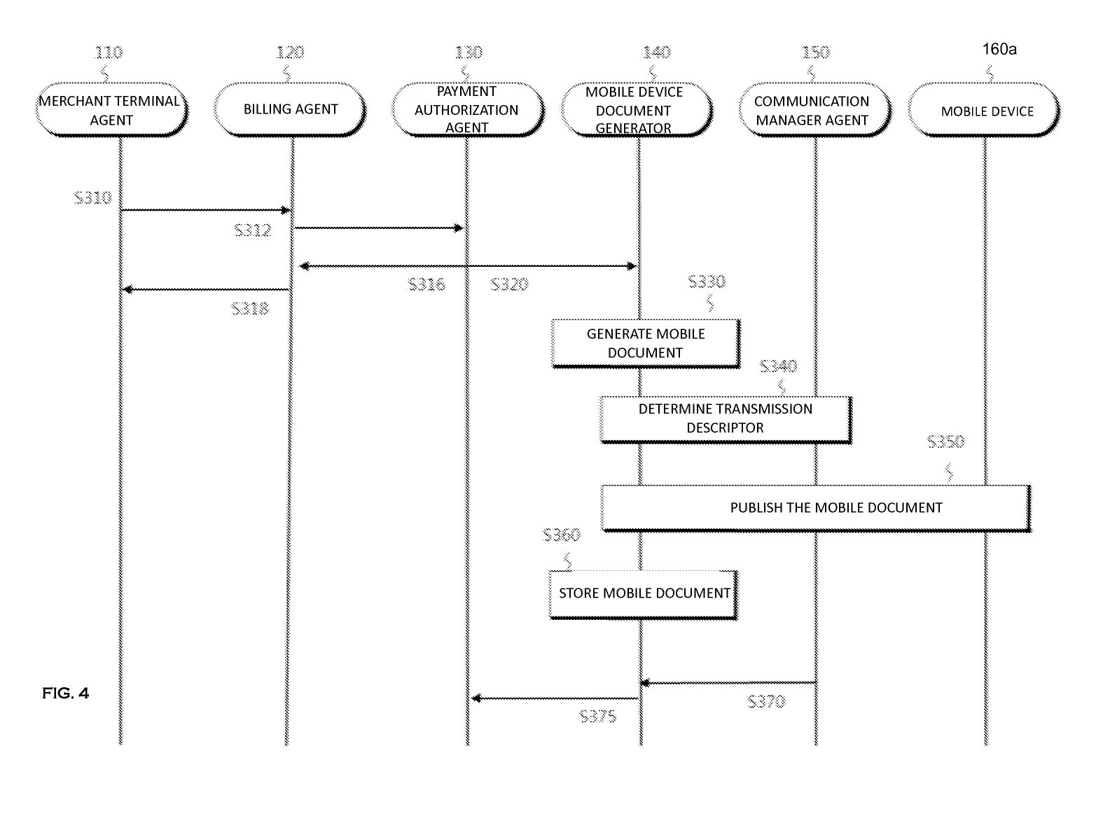

Referring now to FIG. 4, a process flow of an exemplary smart phone (160a) operation will be described in greater detail. As shown, merchant terminal agent 110 sends a transaction request to billing agent at S310, which is then sent to payment authorization agent 130 at S312. Payment authorization agent 130 approves or denies the transaction request and, in the case of approval, sends authorization to billing agent 120 at S316 and to mobile device document generator 140 at S320. The approval history is sent to merchant terminal agent 110 at S318. In one embodiment, the approval history includes the identifier for the mobile device, payment date, payment location, cost, etc.

Next, mobile device document generator 140 generates the mobile document based on the details of the transaction at S330, and the communication transmission mode is determined from the transmission descriptor at S340. The mobile document is then published at S350 according to the communication transmission mode. In exemplary embodiments, mobile journal/slip agent sends the mobile document to mobile agent 160 in push mode (e.g., Apple® Push Notification or Android® Cloud to Device Messaging). (Apple is a registered trademark of Apple Computer, Inc. of Cupertino, Calif. in the United States and other countries. Android is trademark of Google Inc. of Mountain View, Calif. in the United States and other countries.) The mobile document may then be viewed by the user via a display component of mobile device 160a, and the mobile document is then stored at S360. Communication manager agent 150 feeds back the status to mobile device document generator 140 at S370 and to payment authorization agent 130 at S375.

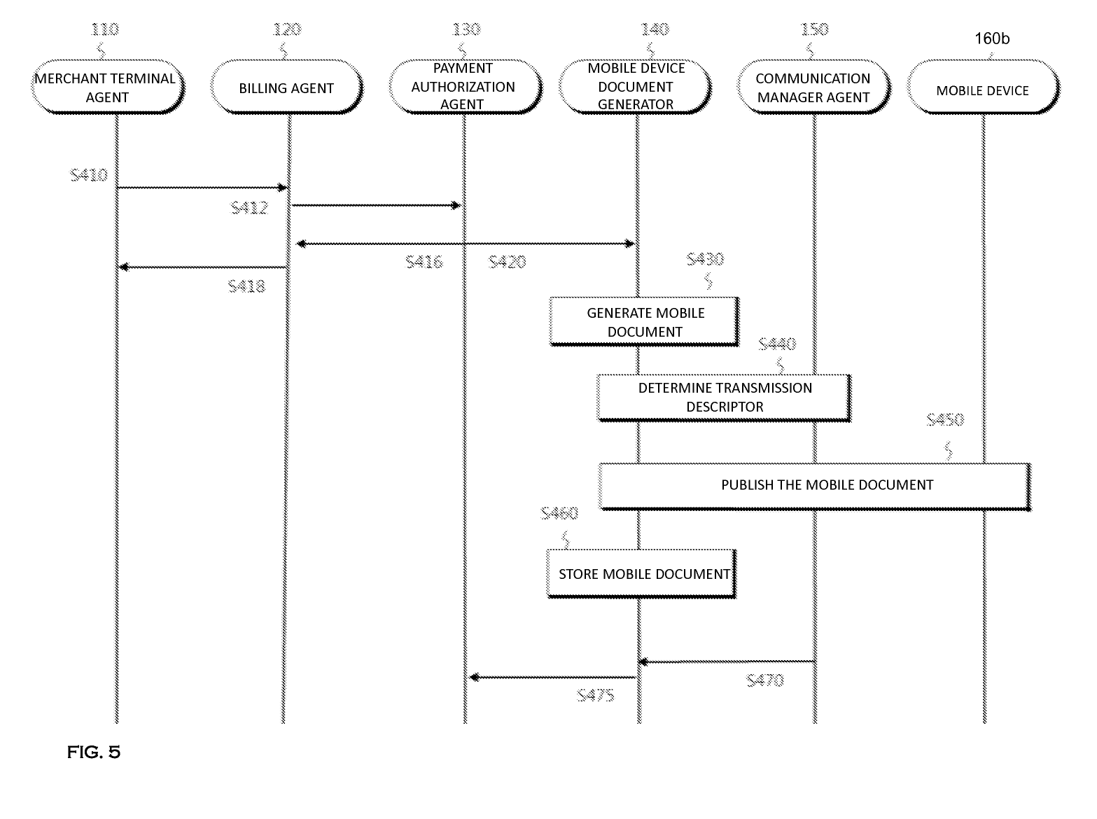

Referring now to FIG. 5, a process flow of an exemplary feature phone (160b) will be described in greater detail. As shown, merchant terminal agent 110 sends a transaction request to billing agent 120 at S410, which is then sent to payment authorization agent 130 at S412. Payment authorization agent 130 approves or denies the transaction request and, in the case of approval, sends authorization to billing agent 120 at S416 and to mobile device document generator 140 at S420. The approval history is sent to merchant terminal agent 110 at S418. In one embodiment, the approval history includes the identifier for the mobile device, payment date, payment location, cost, etc.

Next, mobile device document generator 140 generates the mobile document based on the details of the transaction at S430, and the communication transmission mode is determined from the transmission descriptor at S440. The mobile document is then published at S450 according to the communication transmission mode. In exemplary embodiments, mobile journal/slip agent sends the mobile document to mobile agent 160 in push mode. In this embodiment, the push mode may be MMS. The mobile document may then be viewed by the user via a display component of mobile device 160b. The mobile document is then stored at S460. Communication manager agent 150 feeds back the status to mobile device document generator 140 at S470 and to payment authorization agent 130 at S475. In this embodiment, if delivery of the mobile document to mobile agent 160b fails, then mobile document publisher 230 (FIG. 3) sends a modified version (e.g., a summary) of the mobile document through cellular network 115b (FIG. 1).

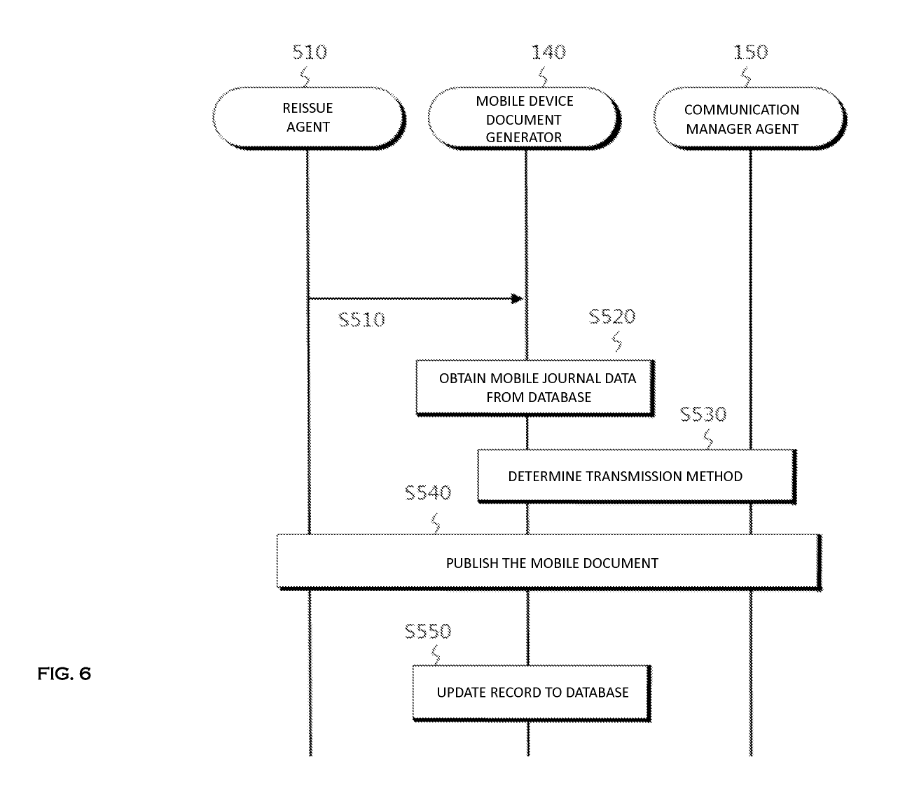

Referring now to FIG. 6, an exemplary process flow for reissuing a mobile document will be described in greater detail. As shown, reissue agent 510 requests a reissue of a mobile journal at S510. Reissue agent 510 may or may not be the same mobile device that previously received the mobile journal or slip. The request may include an approval reference number or the identifier of an ID key of mobile device document generator 140. Next, mobile document publisher 230 (FIG. 3) obtains the mobile journal data that was requested by reissue agent 510 from journal database 240 (FIG. 3) at S520. The transmission method is determined at S530 (e.g., either internet-based network 115a or cellular network 115b), and the journal document is published at S540. Mobile device document generator 140 updates a journal issuance date and adds the record to journal database 240 at S550.

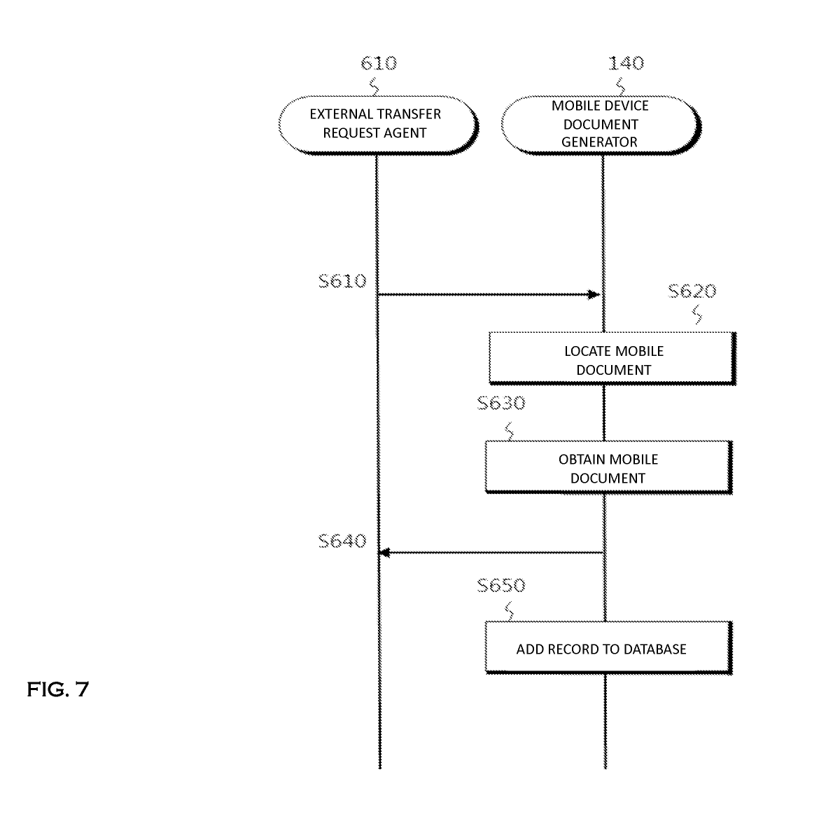

Referring now to FIG. 7, an exemplary process flow for issuing a mobile document in response to an external transfer request is described in greater detail. As shown, an external transfer request is received from an external transfer request agent 610 (e.g., a computer system operated by the user or a third party) at S610. The mobile journal data is located at S620, and obtained from journal database 240 (FIG. 3) at S630. Mobile document publisher 230 (FIG. 3) publishes the mobile document to the external transfer request agent, and the record is added to the journal database 240 at S650.

Referring again to FIG. 1, operation of expenditures agent 170 will described in greater detail. In exemplary embodiments, mobile device document generator 140 may process the transaction data and publish a copy to a destination selected by the user, e.g., expenditures agent 170. In one embodiment, the electronic document may be formatted to provide for interaction with accounting type software for operation with a finance organization (e.g., the Internal Revenue Service). Merely by way of example, the electronic document may be provided to the expenditures agent 170 in a format for use with Quicken® software. (Quicken is a registered trademark of Intuit, Inc., of Mountain View, Calif. in the United States and other countries). In some cases, the mobile documents may be transmitted directly to a third party using a specified format and interface. In this way, a third party could aggregate mobile documents over a specified time and then forward these to the user.

It can be appreciated that the approaches disclosed herein can be used within a computer system to manage electronic documentation of transactions. To this extent, the deployment can comprise one or more of (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary embodiments may be described in the general context of computer-executable instructions, such as program modules, being executed by a computer. Generally, program modules include routines, programs, people, components, logic, data structures, and so on, which perform particular tasks or implement particular abstract data types. An exemplary computer system may be practiced in distributed computing environments where tasks are performed by remote processing devices that are linked through a communications network. In a distributed computing environment, program modules may be located in both local and remote computer storage media including memory storage devices.

The flowcharts of FIGS. 4-7 illustrate the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, as will be described herein, systems/components may also be implemented as a combination of software and one or more hardware devices. For example, mobile device document generator 140 may be embodied in the combination of a software executable code stored on a memory medium (e.g., memory storage device). In a further example, a system or component may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

In one embodiment, an implementation of exemplary computer system 104 may be stored on or transmitted across some form of computer-readable storage medium. Computer-readable storage medium can be media that can be accessed by a computer. “Computer-readable storage medium” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. “Communication medium” typically embodies computer readable instructions, data structures, and program modules. Communication media also includes any information delivery media.

It is apparent that there has been provided an approach for structured communication for managing electronic documentation of transactions. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for managing electronic documentation of transactions, the method comprising the computer-implemented steps of:
receiving information about a transaction entered into by a user;
generating a mobile document containing the information about the transaction;
determining a communication transmission mode based on a type of mobile device of the user; and
sending the mobile document to the mobile device of the user according to the communication transmission mode.

2. The method according to claim 1, the determining the communication transmission mode comprising determining an operating system and a type of mobile device of the user.

3. The method according to claim 1, the mobile document comprising at least one of a mobile journal and a slip.

4. The method according to claim 1, further comprising the computer implemented steps of:
receiving a transaction request from a merchant terminal agent;
retrieving account information from an account of the user; and
generating a transaction approval confirmation comprising an identifier associating the mobile device of the user and the account of the user.

5. The method according to claim 1, further comprising the computer-implemented step of re-issuing the mobile document.

6. A system for managing electronic documentation of transactions, the system comprising:
a memory medium comprising instructions;
a bus coupled to the memory medium; and
a processor coupled to a mobile device document generator via the bus that when executing instructions causes the system to:
receive information about a transaction entered into by a user;
generate a mobile document containing the information about the transaction;
determine a communication transmission mode based on a type of mobile device of the user; and
send the mobile document to the mobile device of the user according to the communication transmission mode.

7. The system according to claim 6, the instructions causing the system to determine the communication transmission mode further comprising instructions causing the system to determine an operating system and a type of mobile device of the user.

8. The system according to claim 6, the mobile document comprising at least one of a mobile journal and a slip.

9. The system according to claim 6, the instructions further causing the system to:
receive a transaction request from a merchant terminal agent;
retrieve account information from an account of the user; and
generate a transaction approval confirmation comprising an identifier associating the mobile device of the user and the account of the user.

10. The system according to claim 6, further comprising computer instructions causing the system to re-issue the mobile document.

11. A computer-readable storage medium storing computer instructions, which when executed, enables a computer system to manage electronic documentation of transactions, the computer instructions comprising:
receiving information about a transaction entered into by a user;
generating a mobile document containing the information about the transaction;
determining a communication transmission mode based on a type of mobile device of the user; and
sending the mobile document to the mobile device of the user according to the communication transmission mode.

12. The computer-readable storage medium according to claim 11, the computer instructions for determining the communication transmission mode comprising determining an operating system and a type of mobile device of the user.

13. The computer-readable storage medium according to claim 11, the mobile document comprising at least one of a mobile journal and a slip.

14. The computer-readable storage medium according to claim 11, the computer instructions further comprising:
receiving a transaction request from a merchant terminal agent;
retrieving account information from an account of the user; and
generating a transaction approval confirmation comprising an identifier associating the mobile device of the user and the account of the user.

15. The computer-readable storage medium according to claim 11, further comprising computer instructions for re-issuing the mobile document.

16. A method for managing electronic documentation of transactions, the method comprising:
receiving, by a computer system, information about a transaction entered into by a user;
generating, by the computer system, a mobile document containing the information about the transaction;
determining, by the computer system, a communication transmission mode based on a type of mobile device of the user; and
sending, by the computer system, the mobile document to the mobile device of the user according to the communication transmission mode.

17. The method according to claim 16, the determining, by the computer system, the communication transmission mode comprising determining an operating system and a type of mobile device of the user.

18. The method according to claim 16, the mobile document comprising at least one of a mobile journal and a slip.

19. The method according to claim 16, further comprising:
receiving, by the computer system, a transaction request from a merchant terminal agent;
retrieving, by the computer system, account information from an account of the user; and
generating, by the computer system, a transaction approval confirmation comprising an identifier associating the mobile device of the user and the account of the user.

20. The method according to claim 16 further comprising re-issuing, by the computer system, the mobile document.
